(19) United States
(12) Patent Application Publication
(10) Pub. No.: US 2011/0025180 A1
(43) Pub. Date: Feb. 3, 2011

(54) MOUNTING RAIL FOR WALL-MOUNTED STORAGE SYSTEMS

(75) Inventors: Richard J. Ilich, Bronx, NY (US); John T. Jaworski, Far Hills, NJ (US); William E. Burke, Basking Ridge, NJ (US)

Correspondence Address: WARNER NORCROSS & JUDD LLP;INTELLECTUAL PROPERTY GROUP, 900 FIFTH THIRD CENTER, 111 LYON STREET, N.W., GRAND RAPIDS, MI, 49503-2487, US

(73) Assignee: WINQUEST COMPANIES, INC., Holland, MI (US)

(21) Appl. No.: 12/512,689

(22) Filed: Jul. 30, 2009

(51) Int. Cl. A47B 96/00; A47F 5/08; B23P 11/00

(52) U.S. Cl. 312/237; 211/87.01; 29/428

(57) ABSTRACT

A rail system for a wall-mounted storage system includes first and second rails adapted to overlap. The first and second rails each define a plurality of spaced-apart openings, at least some of which are longitudinally elongated. At least one of the elongated openings on the first rail is arranged to be at least partially aligned with at least one of the openings in the second rail to receive one of the fasteners through the partially aligned openings in a wide variety of relative rail positions.

### BACKGROUND OF THE INVENTION

The present invention relates to wall-mounted storage systems and more particularly to mounting rails for such systems.

Wall-mounted storage and shelving systems are used to organize and maximize the storage space is areas such as closets, garages, pantries and other storage areas. Storage systems typically include various combinations of cabinets, panels, shelves, drawers, clothing rods and the like. An example of a such system is disclosed in U.S. Pat. No. 4,928,833. These systems include (a) rails mounted horizontally on a wall and (b) components mounted or suspended on the rail at desired locations. Each rail includes spaced holes adapted to receive screws for securing the rail to a wall.

It is highly desirable in many applications that the rail or rails extend completely across the wall from one corner to the opposite corner so that storage components can be mounted anywhere along the wall. However, the rails typically are manufactured in one or a limited number of fixed lengths, which typically do not directly match the desired length of the system (e.g. the length of a wall). Consequently, the installer has one of two choices. The first choice is to cut at least one of the rails to a specific length so that the rail or rails precisely match the length of the wall. However, cutting the metal rails can be difficult, especially for the do-it-yourselfer, so this choice detracts from the marketability of the product. The second choice is to overlap at least two rails, slide them to the full length of the wall, and then slide them back until the overlapping holes are aligned so that screws can be installed. However, this choice typically results in the rail not fully extending into the corners, making it difficult or impossible to mount storage components adjacent the corners.

### SUMMARY OF THE INVENTION

The present invention is directed to a mounting rail for a wall storage system in which the rails can be mounted to extend fully from corner to corner without the necessity of cutting one of the rails. According to one aspect, the rail defines a plurality of spaced openings, at least some of which are horizontally elongated. Consequently, the openings in overlapping rails are aligned in a wide variety, and indeed infinite number of, rail positions. This enables the rails to consistently extend the full length of a wall from one corner to the opposite corner.

According to a second aspect of the invention, the invention includes a method of installing a storage system using the rails. The method includes the steps of: (a) providing first and second rails each defining a plurality of openings, at least some of which are elongated; (b) securing the first rail to the wall; (c) positioning at least a portion of the second rail over at least a portion of the first rail and at least partially aligning at least one of the elongated openings in the second rail with at least one of the openings in the first rail; (d) installing a fastener through the partially aligned openings; and (e) mounting a storage component on at least one of the first and second rails.

The rails can be overlapped at a wide variety of relative longitudinal positions with openings to enable installation in all of the positions. The rails eliminate the need to cut rails while still providing rails that extend fully into corners. These and other advantages and features of the invention will be more fully understood and appreciated by reference to the description of the current embodiment and the drawings.

### BRIEF DESCRIPTION OF THE DRAWINGS

FIG. 1 is a perspective view of a storage system in accordance with the current embodiment of the invention.

FIG. 2 is a perspective view a portion of the system of FIG. 1.

FIG. 3 is an enlarged perspective view of a portion of the system of FIG. 1.

FIG. 4 is a perspective view of a rail in the system of FIG. 1.

FIG. 5 is a front elevational view of first and second overlapped rails.

FIG. 6 is another front elevational view of the first and second overlapped rails.

FIG. 7 is a perspective, exploded view of the first and second rail and a cover.

### DESCRIPTION OF THE CURRENT EMBODIMENT

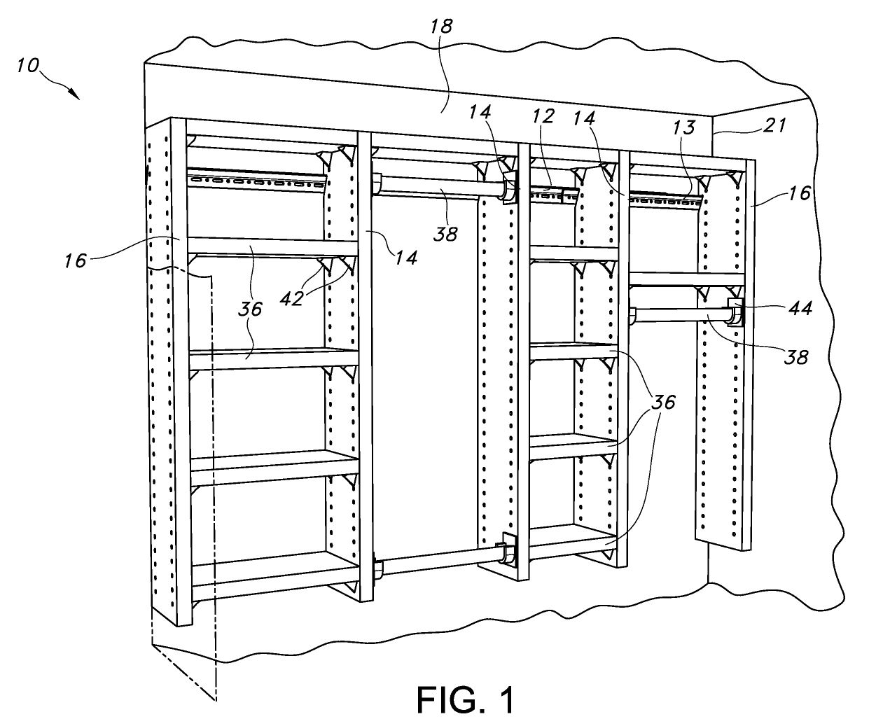

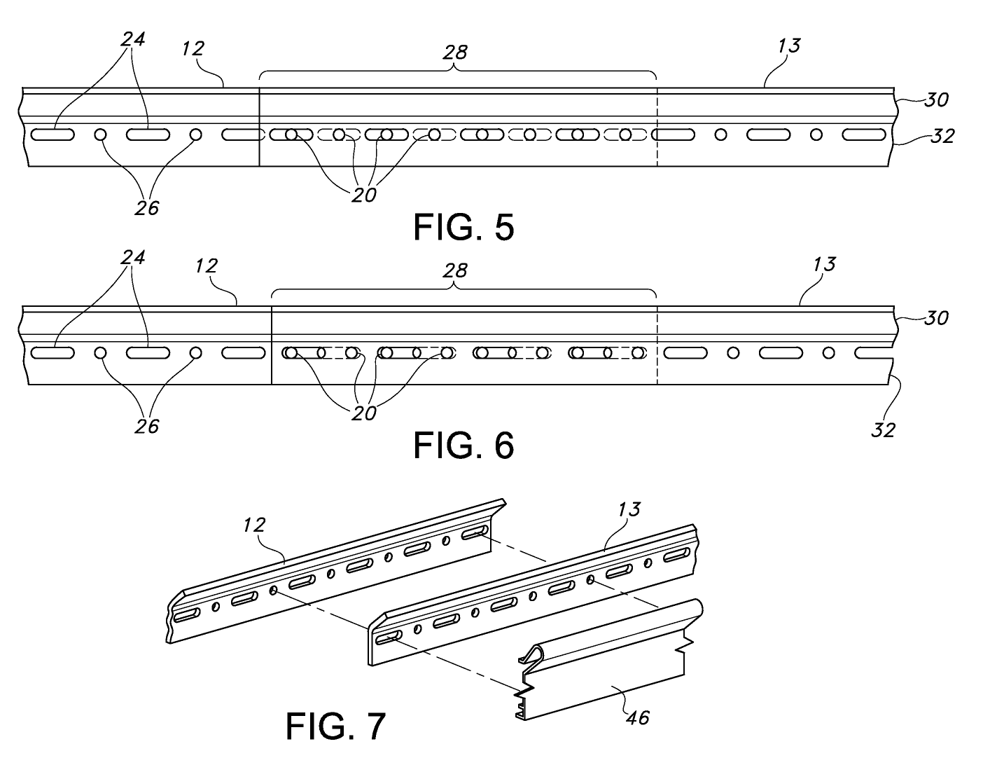

A storage system constructed in accordance with the current embodiment of the invention is shown in FIG. 1 and is generally designated 10. The system 10 includes first and second rails 12 and 13 that are adapted to be secured to a wall 18. The rails 12 define a series of spaced-apart openings 26, at least some of which are elongated openings 24. The openings 24 and 26 are adapted to receive a plurality of fasteners 22 (FIG. 3). As shown in FIGS. 5 and 6, the second rail 13 can be at least partially overlapped with the first rail 12, which creates an overlapped section 28. The openings 24 and 26 are arranged in the upper rail 13 so that at least one of the elongated openings 24 is at least partially aligned with one of the openings 24 or 26 in the first rail 12. A fastener 22 can then be received through the partially aligned openings 20. A storage component, such as an upright panel 14 or end panel 16, can then be removably mounted on at least one of the rails 12 and 13.

### I. System

The rails 12 and 13 can be formed in any suitable shape and length. As shown in FIGS. 1-3, the rails 12 and 13 are formed as elongated rails having a first leg 32 adapted to be secured to a wall and a second leg 30 that extends away from the wall 18, at angle with respect to the first leg 32. The rail can optionally be angled at its longitudinal center to produce the two legs 30, 32. The legs 30, 32 can be arranged at any suitable angle with respect to each another. For example, in the illustrated embodiment, the first leg 32 is adapted to lay substantially flat against the wall 18, and the second leg 30 extends away from the wall 18 at an approximately 50 degree angle with respect to the first leg 32. In the illustrated embodiment, the rails 12 and 13 have a similar profile, such that the rails 12 and 13 are able to “nest” or lie substantially against each other. Optionally, the rails 12 and 13 can have a standard length, for example, approximately four or eight feet, and can have a standard width, for example, approximately 1.5 inches. The rails 12 and 13 can be formed from any suitable material, including but not limited to 12 gauge steel.

The first leg 32 defines the openings 26 and elongated openings 24. While the openings 24 and 26 are shown in the illustrated embodiment as rounded slots and round openings, respectively, the openings 24 and 26 can alternatively have squared edges or can be formed in any other suitable shape. Further, the openings 26 can also optionally be elongated.

The rails 12 and 13 can each include any desired number of openings 24 and 26. Optionally, the first and second rails 12 and 13 can include at least a minimum number of openings 24 and 26 to ensure that at least one of the elongated openings 24 on the second rail 13 is aligned with at least one of the openings 26 in the first rail 12. For example, as shown in FIGS. 4-6, the openings 24 and 26 can be evenly spaced along a line along the length of the rails 12 and 13. Optionally, the openings 24 and 26 can be approximately 0.50 inches apart. The elongated openings 24 can be arranged lengthwise along the length of the rails 12 and 13.

The openings 24 and 26 can be formed in any suitable size. For example, the elongated openings 24 can be approximately 0.75 inches long, while the openings 26 can have a radius of approximately 0.25 inches. It can be more likely that the openings 24 and 26 of the first and second rails 12 and 13 will overlap when the length of the elongated openings 24 is greater than the spacing between the openings 24 and 26.

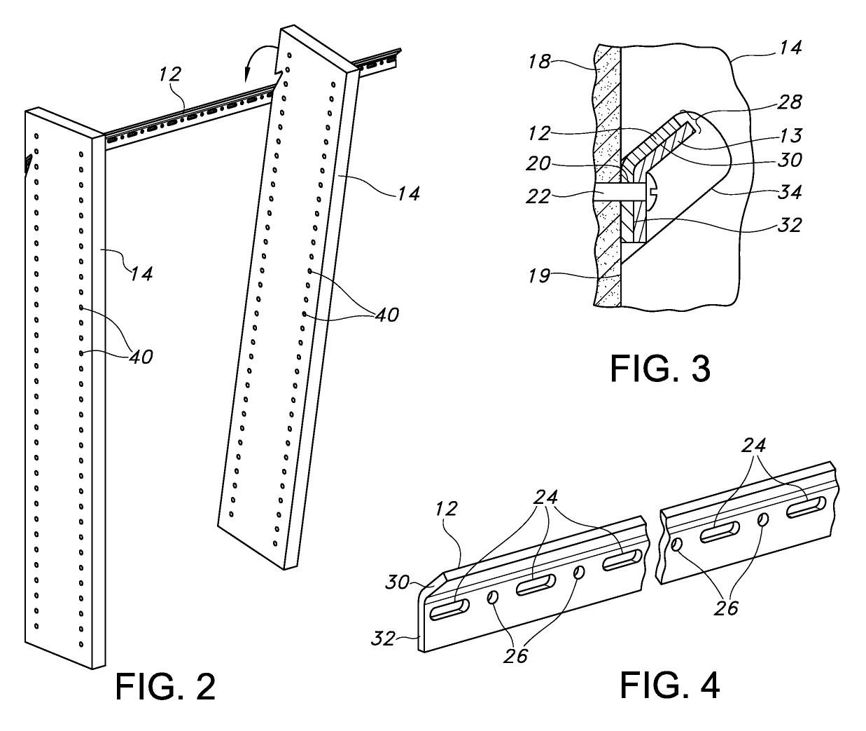

Any suitable storage components, including upright panels 14 and end panels 16, can be mounted to the rails 12 and 13. Optionally, the panels 14 and 16 can each include a cutout 34 in a rear edge 19 of the respective panel that is adapted to abut the wall 18 (FIGS. 2 and 3). The cutout 34 can be formed on an angle that generally corresponds to the angle of the second leg 30 of the rails 12 and 13. The cutout 34 can also have a depth that is at least as long as the second leg 30, such that the cutout 34 is adapted to receive the leg 30 when the panel is in a generally upright position. In this configuration, the panels 14, 16 can be placed or hung or mounted on the leg 30 of rail 12. As shown in FIG. 3, the cutout 34 can optionally be sized to accommodate both the rail 12 and the rail 13 in an overlapped configuration, such that the panels 14 and 16 can be mounted to the rails in the overlapped section 28.

The panels can optionally be approximately 48″ long, 12″ wide and ⅝″ thick. However, the panels 14, 16 can be selectively formed in any desired length, width and thickness to accommodate a particular system 10. The panels 14, 16 can also be formed from any suitable material, including but not limited to a laminated material, plastic, wood or the like. The panels 14 and 16 can optionally include two vertical rows of holes 40 along the length of each side of the panels for receiving end supports 44 for clothing rods 38 and/or pins or supports 42 for supporting shelves 36 (FIG. 1). Optionally, the panels 14 and 16 can be selectively spaced along the rails 12 and 13 to accommodate the shelves 36 and rods 38. Because the panels are removably mounted to the rails 12 and 13, the panels can be adjusted to create a desired distance between the respective panels.

Optionally, a cover 46 can be placed over the rails 12 and 13. The cover 46 can be sized so that the cover 46 can receive one of the rails 12 or 13, or both of the rails 12 and 13, in an overlapped orientation. The cover 46 can be snap-fitted over the rails 12 and/or 13 or can slide onto the rails 12 and 13.

### II. Installation

The first rail 12 can be secured to the wall 18 at a desired height above the floor using any suitable fastener 22. For example, the rail 12 can be mounted and secured to studs of the wall 18 using screws or the like, which can be positioned through at least one of the openings 24 and 26 in the first leg 32 of the rail 12.

Rails 12 are typically aligned, end-to-end, along the entire length of a wall 18 until they abut a corner wall 21 (FIG. 1). Optionally, one end of the rails can include a truncated extension, while the opposite end of the rails includes a corresponding cutout or recess, such that the ends of adjacent rails 12 can be connected. Because the standard length of the rails 12 typically will not allow the end of the last rail 12 to reach the corner wall 21, one end of the second rail 13 can be positioned to abut the corner wall 21, which causes at least a portion of the rail 13 to overlap the rail 12. This results in the overlapped section 28 between the rails 12 and 13 (FIGS. 1 and 5-6). Fasteners 22 can then be inserted through the overlapped openings 20, to secure both of the rails 12 and 13 to the wall 18. Fasteners can also be installed through the openings 24 and 26 in the portion of rail 13 that does not overlap rail 12.

Because the length of the space between the end of the last rail 12 and the corner wall 21 will vary depending on the length of the wall 18, the length of the overlapped section 28 will also vary. Thus, as discussed in detail above, the openings 24 and 26 can be shaped, sized, positioned and spaced to create at least one overlapped opening 20 in a variety of orientations. For example, as shown in FIG. 5, the second rail 13 is positioned over the rail 12 to create a series of generally centered overlapped openings 20. As shown in FIG. 6, in comparison, the second rail 13 is positioned over the rail 12 to create a different pattern of overlapped openings 20. However, regardless of the specific positioning of the rail 13 over the rail 12, a sufficient number of overlapped openings 20 are created to secure the overlapped portion 28 to the wall 18 in at least 90% of possible positions. Thus, at least a minimum number of fasteners 22 can be installed through the overlapped openings 20 to secure both rails 12 and 13 to the wall 18 in at least 90% of all possible positions.

The panels 14 and 16 can then be hung on the rails 12 and 13, including in the overlapped section 28, in any desired configuration. As shown in FIG. 1, one end panel 16 is mounted to the rail 13 adjacent the corner wall 21, and another end panel is positioned at an end of the rail positioned at an opposite end of the wall 18. The positioning of rail 13 against the corner wall 21 can assist in maximizing the length of the system 10 and, therefore, the available storage space. The upright panels 14 can be selectively mounted along the rails 12 and 13 between the end panels 16.

To mount the panels 14 and 16 to the rails 12 and 13, the panels 14 and 16 are hung so that the cutout 34 receives the second leg 30 of the rails 12 and/or 13. The panels 14 and 16 can be positioned so that the rear wall 19 of the panels abuts the wall 18. Once the panels 14 and 16 are mounted, the shelves 36 and rods 38 and any other storage components can be mounted between the panels 14 and 16. Optionally, pins or supports can be inserted into the openings 40 in the panels 14 and 16, and the shelves 36 and rods 38 can be placed or mounted on the pins or supports. The space between the panels 14 and 16 can be adjusted based on the desired length of shelves 36 and rods 38 or other components.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A wall-mounted storage system comprising:
first and second rails adapted to overlap at a plurality of relative longitudinal positions, the first and second rails each defining a plurality of spaced-apart openings, at least some of which are longitudinally elongated, at least one of the elongated openings on the second rail aligned with at least one of the openings in the first rail in a plurality of the relative longitudinal positions, whereby the aligned openings can receive a fastener; and
a storage component adapted to be mounted to at least one of the rails.

2. The system of claim 1 wherein the elongated openings are arranged generally lengthwise along the length of the rail.

3. The system of claim 2 wherein the openings are arranged along a line.

4. The system of claim 3 wherein the openings are evenly spaced along the length of the rail.

5. The system of claim 4 wherein the openings and the elongated openings are arranged in an alternating pattern.

6. The system of claim 5 wherein the elongated openings are approximately 0.75 inches long and wherein the openings are spaced approximately 0.50 inches apart.

7. The system of claim 1 wherein the first and second rails each include a first leg adapted to be secured to the wall and a second leg extending away from the wall at an angle with respect to the first leg, wherein the openings are defined in the first leg of the rail.

8. The system of claim 7 wherein the first and second rails have similar profiles, wherein the second rail is adapted to lay against the first rail.

9. The system of claim 1 including a cover adapted to be fitted over at least one of the first and second rails.

10. A method of forming a storage system adapted to be positioned adjacent a wall, comprising:
providing first and second rails each defining a plurality of openings, at least some of which are longitudinally elongated;
securing the first rail to the wall by inserting a first fastener through one of the openings;
positioning at least a portion of the second rail over at least a portion of the first rail, wherein at least one of the elongated openings on the second rail is arranged to be at least partially aligned with at least one of the openings in the first rail;
securing the second rail to the wall by inserting a second fastener through the partially aligned openings; and
mounting a storage component on at least one of the first and second rails.

11. The method of claim 10 wherein the first and second rails each include a first leg adapted to be secured to the wall and a second leg extending away from the wall at an angle with respect to the first leg, wherein the method includes securing the first leg of the first rail to the wall.

12. The method of claim 11 wherein the first and second rails have similar profiles, wherein positioning at least a portion of the second rail over at least a portion of the first rail includes laying the second rail against the first rail.

13. The method of claim 12 including a placing a cover over at least one of the first and second rails.

14. A rail assembly, comprising:
a first rail adapted to be secured to a wall;
a second rail adapted to at least partially overlap the first rail, wherein the first and second rails each include a first leg adapted to be secured to the wall and a second leg extending away from the wall at an angle with respect to the first leg, wherein the first leg of each of the first and second rails defines a plurality of spaced-apart openings, at least some of which are longitudinally elongated, wherein at least one of the elongated openings on the second rail is arranged to be at least partially aligned with at least one of the openings in the first rail at a plurality of relative positions of the rails.

15. The rail assembly of claim 14 wherein the elongated openings are arranged generally lengthwise along the length of the rail.

16. The rail assembly of claim 15 wherein the openings are arranged along a line.

17. The rail assembly of claim 16 wherein the openings are evenly spaced along the length of the rail.

18. The rail assembly of claim 17 wherein the openings and the elongated openings are arranged in an alternating pattern.

19. The rail assembly of claim 18 wherein the elongated openings are approximately 0.75 inches long and wherein the openings are spaced approximately 0.50 inches apart.
